(19) United States
(12) Patent Application Publication
(10) Pub. No.: US 2025/0187352 A1
(43) Pub. Date: Jun. 12, 2025

(54) SYSTEM AND METHOD FOR PRINTING PACKAGES

(71) Applicant: Cryovac, LLC, Charlotte, NC (US)

(72) Inventors: Theodore F. Cyman, Minneola, FL (US); Alan Ronald Murzynowski, Grand Island, NY (US); Daniel Edward Kanfoush, Grand Island, NY (US); Frank J. Rocco, N. Tonawanda, NY (US); Anthony Vincent Moscato, N. Tonawanda, NY (US); Paul A. Coniglio, East Amherst, NY (US)

(21) Appl. No.: 18/844,424

(22) PCT Filed: Mar. 7, 2023
(86) PCT No.: PCT/US2023/014671

§ 371 Date: Sep. 6, 2024

Related U.S. Application Data
(60) Provisional application No. 63/317,191, filed on Mar. 7, 2022.

(51) Int. Cl. B41J 11/00; B41J 2/21; B41J 25/00; B41J 25/308; B65B 61/26; G01B 3/18; G01B 5/06; G01B 11/06

(52) U.S. Cl. CPC B41J 11/008; B41J 2/2103; B41J 11/0095; B41J 25/001; B41J 25/308; B65B 61/26; G01B 3/18; G01B 5/061; G01B 11/0608

(57) ABSTRACT

A printing system includes a conveyor, at least one ink jet head, and an actuator operable to move the at least one ink jet head relative to the conveyor. A first sensor and a second sensor are adapted to sense a particular dimension and an entire area of a surface of a package, respectively. A control system is responsive to the first sensor and the second sensor and is operable to position the at least one ink jet head for printing. A method of printing is also disclosed.

### CROSS-REFERENCE TO RELATED APPLICATIONS

This application claims the benefit and priority to U.S. Patent Application Ser. No. 63/317,191, filed Mar. 7, 2022 and entitled “System and Method For Printing Packages”, the entirety of which is incorporated herein by reference.

### BACKGROUND

The subject matter disclosed herein relates to printing systems and methods, and more particularly, to a system and method for printing on one or more packages.

Printing systems have been developed for printing on labels wherein the labels are attached to packages that are to be shipped. While such labels can be customized with addressee information, other indicia, and one or more customized images, such labels typically are all of the same size or a limited number of sizes, and are applied to packages, such as boxes, that may be of different sizes and shapes. This results in the need to utilize separate label application devices that are complex and costly.

The discussion above is merely provided for general background information and is not intended to be used as an aid in determining the scope of the claimed subject matter.

### BRIEF DESCRIPTION

According to one aspect, a printing system includes a conveyor, at least one ink jet head, and an actuator operable to move the at least one ink jet head relative to the conveyor. A first sensor and a second sensor are adapted to sense a particular dimension and an entire area of a surface of a package, respectively, A control system is responsive to the first sensor and the second sensor and is operable to position the at least one ink jet head for printing. A method of printing is also disclosed.

According to another aspect, a method of printing on packages comprises the steps of operating a first sensor to measure a dimension of a package to obtain an approximate dimension measurement, establishing a position of a second sensor in dependence upon the approximate dimension measurement, and operating the second sensor to measure the dimension of the package to obtain a further dimension measurement. The method further includes the steps of disposing a print apparatus at a position dependent upon the further dimension measurement and operating the print apparatus to print on a surface of the package.

Other aspects and advantages will become apparent upon consideration of the following detailed description and the attached drawings wherein like numerals designate like structures throughout the specification.

This brief description is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIGS. 1 and 2 are simplified isometric views of system for printing on a package taken from opposite ends thereof;

FIGS. 3A and 3B are front and rear isometric views, respectively, with front and back panels removed, respectively, of the second sensor, print system, and control system of FIGS. 1 and 2;

FIGS. 4 and 5 are front and side elevational views, respectively, of the apparatus of FIG. 3;

FIG. 6 is a plan view of the apparatus of FIGS. 3A and 3B;

FIGS. 7A and 7B, when joined along similarly lettered lines, together comprise a flowchart of operation of the system of FIG. 1;

FIG. 8 is a simplified block diagram of the system 28 of FIG. 1;

FIG. 9 is a simplified isometric view of the second sensor of FIGS. 1-6;

FIGS. 10 and 11 are enlarged, fragmentary, isometric views with portions removed therefrom of the apparatus of FIGS. 3A and 3B illustrating the movable print head housing; and

FIGS. 12A and 12B are simplified schematic front elevational views with portions removed therefrom illustrating the movable print head housing during printing on different size packages.

### DETAILED DESCRIPTION

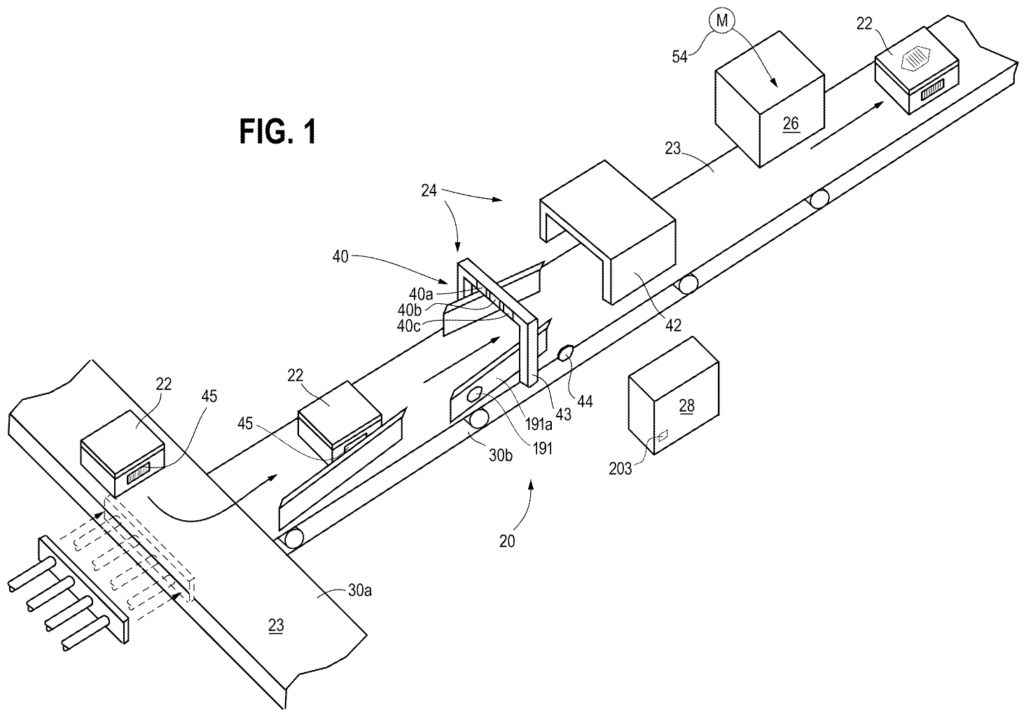

Referring to FIGS. 1, 2, and 8, a system 20 for marking packages, such as sealed boxes 22 that are loaded with one or more items to be shipped, includes a conveying system 23 for transporting one or more packages, such as boxes 22, a sensor system 24, a print system 26, and a control system 28. The conveying system 23 comprises at least one, and preferably, multiple conveyors (two conveyors 30a and 30b are in the illustrated embodiment) that move the boxes 22 in a continuous manner along one or more main transport paths to and past the sensor system 24 and the print system 26 in sequence. Diverter gates, positioning apparatus, and other conveyor components are typically included as part of the conveying system 23.

In one embodiment, the conveying system 23 operates at a speed between approximately 80 and approximately 90 feet per minute to move the boxes 22 past the print system 26. In other embodiments, the conveying system 23 operates at a speed between approximately 120 and approximately 150 feet per minute. Further, in some embodiments, the conveying system 23 operates to move between approximately 30 and approximately 40 boxes per minute past the print system 26.

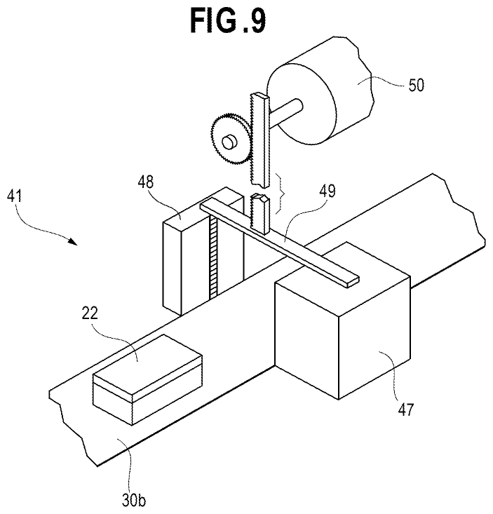

In the illustrated embodiment, the sensor system 24 comprises a first sensor 40 and a second sensor 41 (seen in FIG. 9 and described in greater detail hereinafter) disposed in a housing portion 42 downstream (in the conveying direction) of the first sensor 40. Also in the illustrated embodiment, the first sensor 40 comprises spaced first through third range-finding light emitter/detectors 40a, 40b, 40c fixed at a particular height on a support member 43 above the conveyor 30b, although the first sensor 40 may instead be disposed at a fixed height above any of the conveyor(s) 30 upstream of the second sensor in the housing portion 42. Each of the light emitter/detectors 40a-40c may comprise a laser distance sensor or any other suitable sensor that develops a signal indicating a distance between the emitter/detectors 40a-40c and a surface of each box 22 as the box 22 is conveyed past the sensor 40. Such distance is representative of a dimension of the box 22. In the preferred embodiment, the top surface of each box 22 is sensed by each of the emitter/detectors 40a-40c at 50 mS intervals and at spaced first through third (or more or fewer) points and such sensed distances is/are provided to the control system 28. A third sensor 44 operated by the control system 28 reads a barcode 45 or other indicia on each box 22 that includes a code comprising an identifier unique to each box 22. The code may be associated with information regarding the contents of the box, the intended recipient of the box, dimensions of the box, and other characteristics of the box, such as the type of box, box color, or other information as necessary or desirable. Optionally, the code may also specify or be associated with one or more dimensions of the associated box. The third sensor 44 reads the barcode 45 and provides the code encoded therein to the control system 28. If the box dimensions can be determined from the code (e.g., if the dimensions are encoded in the code or if the code may be used to retrieve the dimensions from a memory or a device accessible by the control system 28), the box height may be confirmed by the control system 28 by comparing the dimensions determined from the code to the height measured by one or both of the first and second sensors 40, 41. Alternatively, the first sensor 40 is not needed when the approximate box height can be determined from the code information and may be omitted.

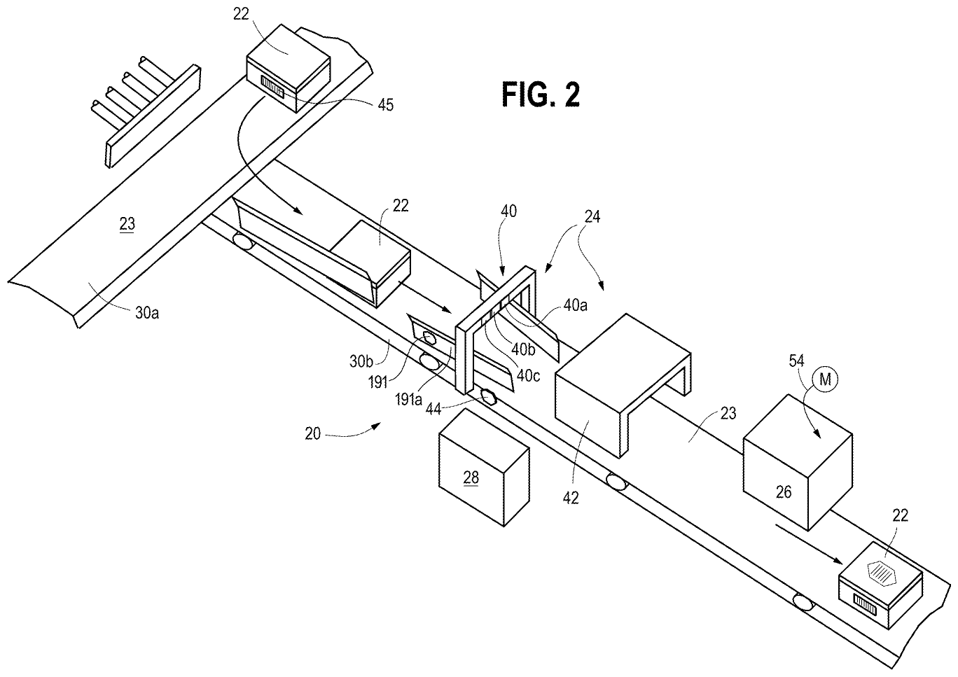

In the illustrated embodiment of FIGS. 1 and 2, the measured distances of each box 22 are used by the control system 28 to derive localized indications of box heights at a first, relatively coarse resolution. Each localized indication may be considered a rough or approximate height indication inasmuch as the particular box height is repeatedly determined at only three locations. In other embodiments, relatively few (compared to the second sensor 41) single or multiple distance measurements may be obtained by each of at least one emitter/detector 40 at separate locations of the top surface of each box 22 and, for example, in the case where multiple distance measurements are obtained, the multiple distance measurements for each box 22 may be averaged or otherwise combined or considered to obtain the rough or approximate box height indication. Thus, in an embodiment, two distances may be measured for each box 22 by a single emitter/detector 40 and the average of the two distances may be calculated by the control system 28 and used as the rough or approximate height indication.

In the illustrated embodiment, the three emitter detectors 40a-40b are operated at an accuracy of 25-40 thousandths of an inch.

Referring also to FIG. 9, in the illustrated embodiment, the second sensor 41 comprises an IG series multi-purpose CCD laser micrometer sold by Keyence Corporation of America of Itasca, Illinois. The second sensor 41 comprises spaced emitter and CCD detector portions 47, 48, respectively, that are coupled together by a structural member 49 for joint up and down movement by a motor 50 operated by the control system 28. The rough or approximate height indication obtained as noted above is used by the control system 28 to operate the motor 50 in turn to position the second sensor 41 at such height before the associated box 22 reaches a predetermined distance in advance of the second sensor 41. In this regard, a center (in the up and down direction) of the second sensor 41 is positioned and settled at the rough or approximate height before the leading edge of the box 22 reaches the sensor 41 so that accurate further measurements of box height can be obtained.

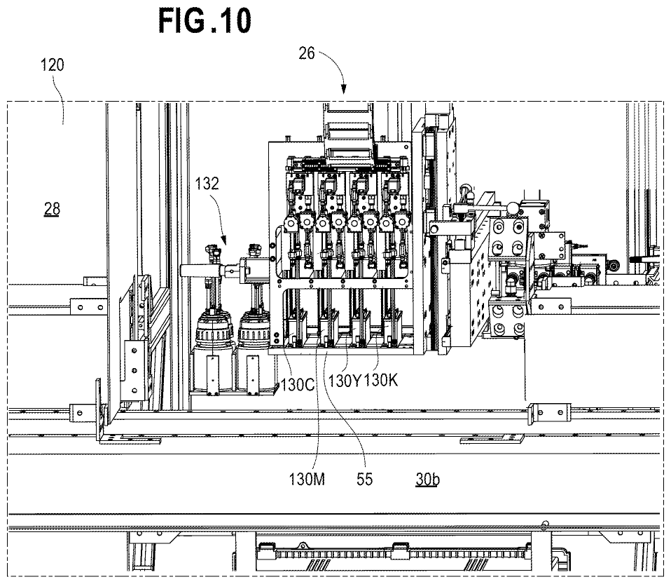

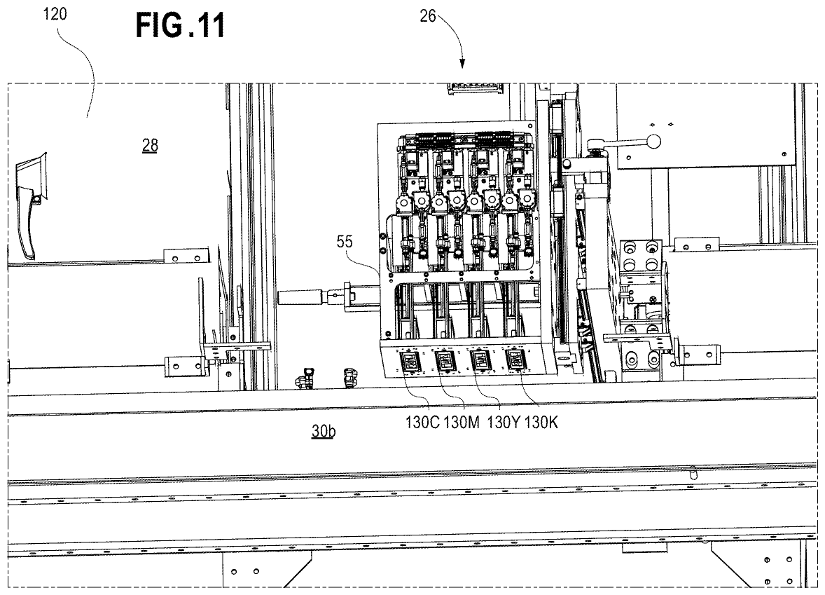

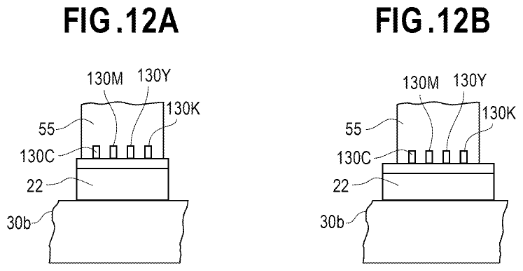

The sensor 41 is also operated by the control system 28 and measures a dimension of the box 22, such as the height of the box 22, over the entire area of the upper surface thereof in a precise manner at various locations thereof and provides the height measurements to the control system 28. The second sensor 41 may be considered as detecting the dimension of the package at a second resolution finer than the first resolution inasmuch as the second sensor 41 has a substantially greater accuracy than the first sensor 40. The control system 28 determines whether the height measurements indicate that the box should not be printed, inasmuch as the top surface thereof has a projection, defect, and/or foreign object thereon that would prevent acceptable print quality from being obtained and/or hinder or even damage one or more components of the print system 26. If this is found to be the case, the control system 28 operates an actuator, such as a motor 54, which moves a print head housing 55 (seen in FIGS. 10, 11, 12A, and 12B) upwardly. Such action spaces the printing portion of the print system 26 away from the top of the box so that printing and possible damage are avoided. On the other hand, if the control system 28 ascertains that the top surface of the box 22 is suitable for printing, the control system 28 operates the motor 54 to position the printing portion of the print system 26 at an appropriate height before the box 22 reaches the print system 26.

Once the box 22 reaches the print system 26, one or more indicia and/or images are printed on the top surface of the box 22 in accordance with print data supplied by the control system 28 as the box 22 traverses the print system 26 and the printed box 22 is conveyed away from the print system for further handling/processing.

The control system 28 may optionally further include one or more downstream sensors (not shown) that check print quality and/or various system parameters such as box positions and conveyor speed, and may further operate one or more actuators, such as motors, that control conveyor movement, diverter gate(s), and the like.

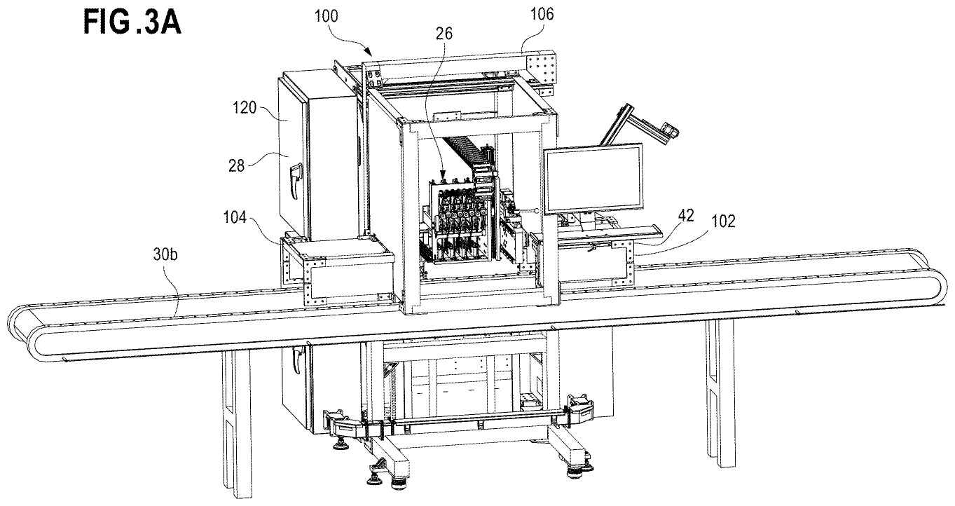

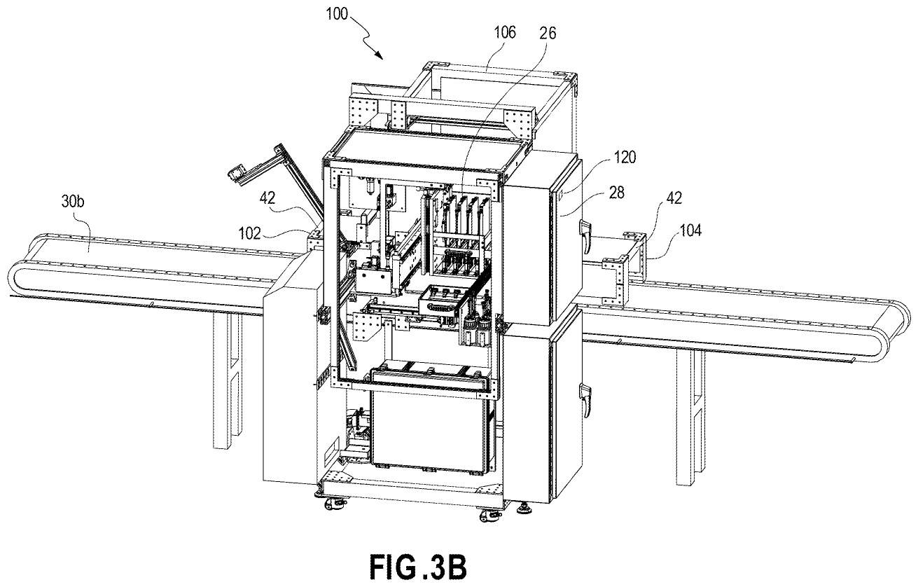

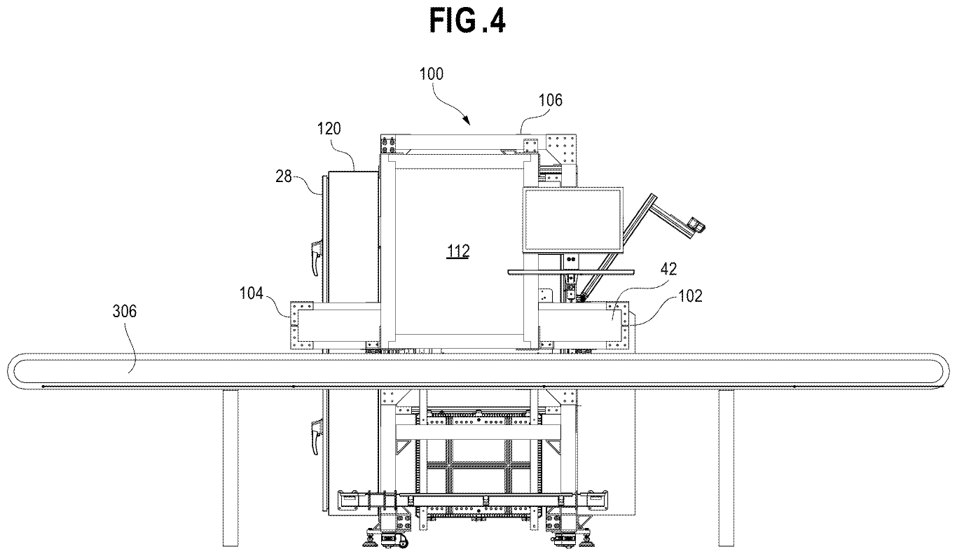

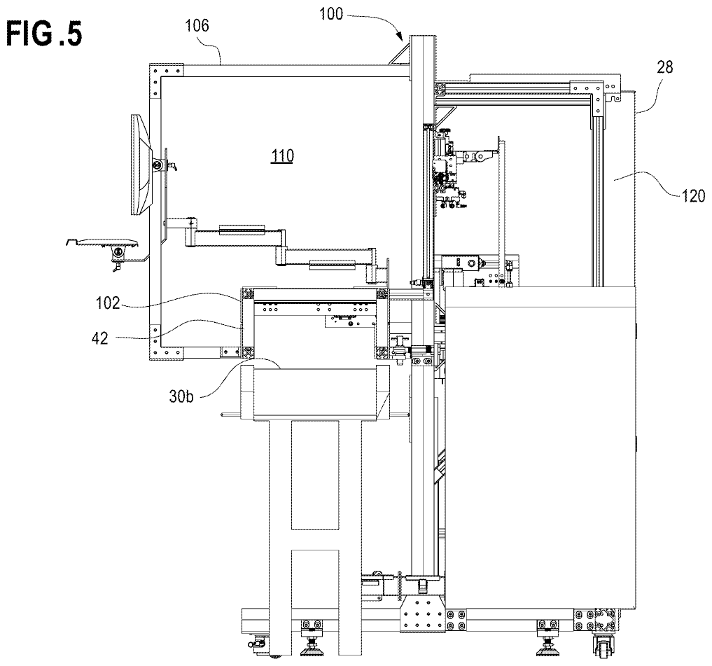

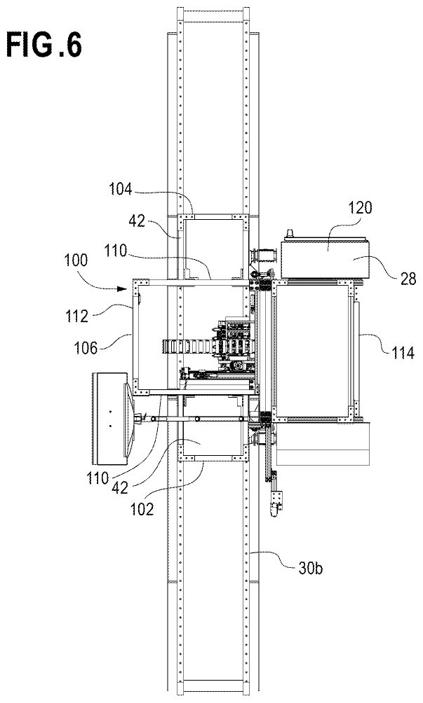

Referring next to FIGS. 3A, 3B, and 4-6, which illustrate portions of the system 20 in greater detail, a frame 100 encloses and supports various elements including the second sensor 41 disposed in the housing 42 and the print system 26. The frame 100 may be constructed of any suitable material, such as tubular steel or aluminum, and is adapted to interface with the conveying system 23 in any suitable manner so that boxes 22 can be transported in a continuous fashion therethrough. The frame 100 includes first and second side portions 102, 104, respectively, and a central portion 106 disposed between the side portions 102, 104. The housing portion 42 is disposed at and comprises the first side portion 102. The frame 100 is integrated with the conveying system 23 such that boxes 22 enter the first side portion 102, travel through the housing portion 42, the central portion 106, and the second side portion 104 in sequence, and exit the frame at the portion 104. The print system 26 is preferably disposed in the central portion 106. The motors 50 and 54 are disposed in the frame 100 and the frame 100 includes side, front, and back panels 110, 112, and 114 (FIG. 6), respectively, that prevent personnel from accessing the second sensor 41, the print system 26, and the motors 50, 54 during operation thereof. One or more the panels 110, 112, and 114 are preferably made of a durable transparent material, such as polycarbonate or glass, and one or more of the panels 110, 112, and 114 may be removable from the frame 100 and/or pivotably mounted on the frame 100 so that such panel(s) can be moved out of the way to permit access to component(s) in the frame 100 when the system 20 is not in use.

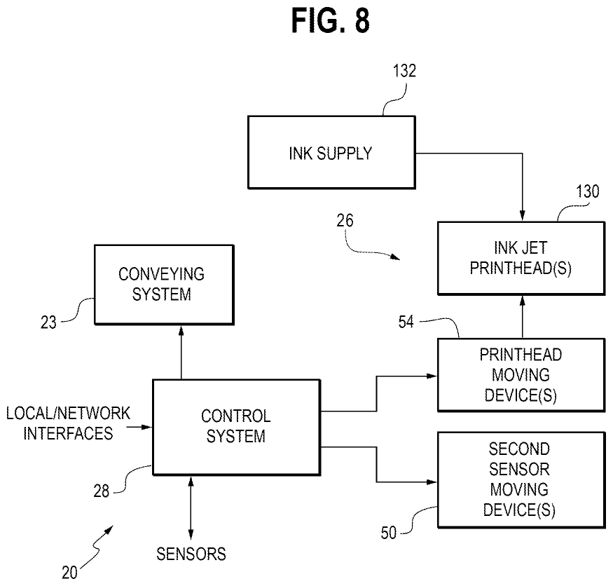

The control system 28 is disposed in a cabinet 120 that may be disposed adjacent the frame 100. As more fully and additionally set forth hereinafter in the Industrial Applicability section, the control system 28 may be implemented by one or more suitably programmed computer-based devices, each comprising, e.g., a desktop or laptop computer, a server, a device using one or more application specific integrated circuits (ASIC's) and/or field-programmable gate arrays (FPGA's), a tablet, a smartphone, etc. and/or combinations thereof. The control system 28 may be unitary or may be distributed across one or more networks. As seen in FIG. 8, the control system 28 is coupled to local and/or networked interfaces, such as a keyboard, a mouse, a display 122 (visible in FIG. 3), a touchscreen, a local area network (LAN), a wide area network (WAN) such as the Internet, etc. The control system 28 is responsive to commands supplied thereto by a user via the local and/or networked interfaces, and further is responsive to sensors and controls motor(s)/actuator(s) as described herein.

Referring to FIGS. 10-12B, the print system 26 comprises one or more ink jet heads 130 that receive ink from an ink supply 132 (visible in FIG. 10) via tubing (not shown for clarity). In the illustrated embodiment, there are at least four ink jet heads 130C, 130M, 130Y, 130K that receive cyan, magenta, yellow, and black inks, respectively, from the ink supply 132. The ink jet heads 130 are drop on demand ink jet print heads either of the piezoelectric or thermal type and may be disposed on a carrier in the form of the movable print head housing 55 that is movable up and down by the motor 54.

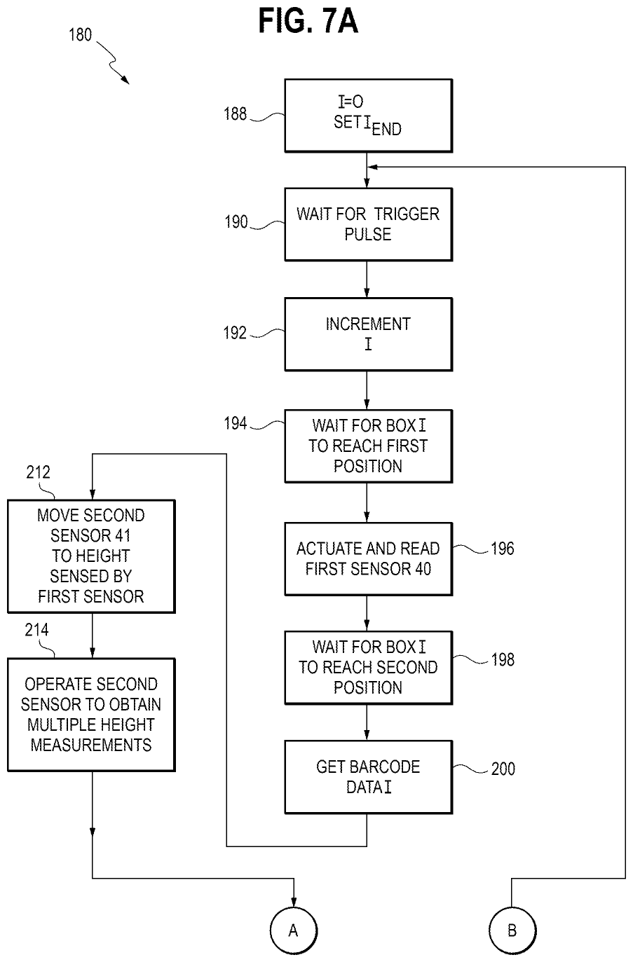

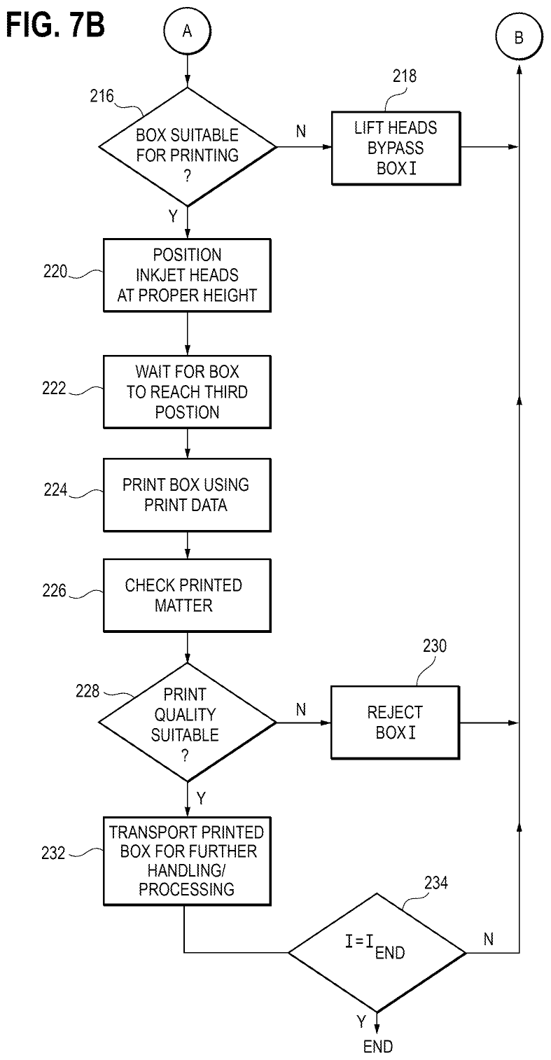

Referring next to FIGS. 7A and 7B, a flow-chart of programming 180 executed by the control system 28 is operable to print multiple boxes that may be of different sizes with printed content. The programming 180 illustrated in FIGS. 7A and 7B is operable as boxes are being continuously transported by the conveying system 23 under control of the control system 28. Further, the programming described hereinafter references and is responsive to a plurality of data blocks provided in a sequence to the control system 28 wherein each data block comprises data associated with a corresponding box 22 to be printed on and an indication of the unique identifier encoded in the barcode 45 on such corresponding box 22. As an example, if 1000 boxes 22-1, 22-2, 22-3, . . . , 22-1000 are to be printed in sequence, a data stream of 1000 data blocks arranged in the same sequence are transmitted to the control system 28 as commands in synchrony with the provision of boxes 22 to the system 20. Such a printing methodology eliminates the need to operate the control system 28 to produce a production database.

The programming begins at a block 188, which sets a process variable I equal to zero. The block 188 also sets a value of a process variable I_{END} to a number of data blocks received by the control system 28 that indicates the number of boxes 22 that are expected to be printed on. A block 190 then pauses programming execution until a trigger pulse is developed by a sensor indicating detection of a box 22 to be printed. The sensor may be the first sensor 40 or a separate sensor disposed in proximity to the conveying system 23. In the illustrated embodiment, a separate sensor 191 (FIG. 1) extends through a side wall of one of the diverters 191a and detects the presence of the barcode 45 of a respective box 22. Once the trigger pulse is detected, control passes to a block 192, which increments the value of I by one and a block 194 pauses execution until the first box 22 (hereinafter designated “box I” comprising a “current box”) that was detected by the block 190 reaches a first position at which the first sensor 40 is to be operated. This determination may be made by the control system 28, which calculates this and other box positions based on the time at which the sensor 191 detects each barcode 45 and the speed of the conveyor. A block 196 then actuates and reads the first sensor 40 and control pauses at a block 198 until the box I reaches a second position at which the barcode 45 is opposite the third sensor 44. When the box I reaches the second position, a block 200 causes the barcode 45 disposed on the box I to be read by the third sensor 44 to develop barcode data I.

Following the block 200, a block 212 moves the second sensor 41 to a position such that the center of the CCD detector portions 48 of the second sensor 41 is positioned at the height indicated by the first sensor 40 when the box was positioned at the first position. It may be noted that, in the illustrated embodiment, the emitter and CCD detector portions 47, 48, respectively, of the second sensor 41 are positioned at least transversely to, and more preferably, substantially or fully perpendicular to the length of the conveyor 30b. Thereafter, a block 214 operates the second sensor 41 at a time when the box I reaches a third position at which the leading edge of the box reaches the second sensor 41 and continues to operate the sensor 41 during the entire time that the box I traverses the sensor 41 to obtain multiple height measurements over the entire length of the box 22. In the illustrated embodiment, the second sensor 41 obtains multiple discrete measurements of the height of the box at separate locations thereof that are equally spaced along the entire length of the box 22 as the box is moving past the second sensor 41. In an embodiment, the sensor 41 supplies readings at a free running rate at 50 mS intervals.

The control system 28 stores the multiple measurements obtained by the block 214 in, for example, the memory 203 and, based on the multiple measurements, a block 216 (FIG. 7B) determines whether the box 22 is suitable for printing. The box 22 may be considered suitable for printing if all of the multiple height measurements are within a predetermined range of values. Alternatively, if one or more of the box height measurements are outside of the predetermined range of values, a conclusion may be reached that the box 22 is not suitable for printing inasmuch as the box top surface is too irregularly shaped or a foreign object is disposed on the box. Failure to account for irregularity in the top surface of the box 22 may result in poor printing or even damage to one or more components of the print system 26, such as the fragile ink jet heads 130. If the box 22 is not considered to be suitable for printing, a block 218 operates the motor 54 to move the movable print head housing 55 upwardly out of possible interfering relationship with the box 22. Print commands that would otherwise be sent to the printheads in connection with the It box 22 are canceled so that such box 22 is bypassed and the unprinted box 22 may thereafter be removed from the conveying system 23 after exiting the second side portion 104. Control then returns to the block 190 of FIG. 7A.

If the block 216 determines that the box 22 is suitable for printing, a block 220 positions the ink jet heads 130 at a proper height for printing by adjusting the position of the movable print head housing 55. In general, ink jet heads 130 should be positioned within a range of heights resulting in a preferred range of gap distances between the bottoms of the ink jet head nozzles and the top surface of the box 22, wherein the preferred range of gap distances is dependent upon the manufacturer and the model and type of ink jet head. In an embodiment, the bottoms of the ink jet head nozzles should be positioned between 0.040 inch and 0.070 inch away from the top surface of the box 22 for best quality printing. Preferably, the ink jet heads 130 are positioned within a range of heights to ensure that the bottoms of the nozzles of the ink jet heads are always within the preferred gap distance range from the top of the box as the entire printing operation is undertaken during movement of the box 22 past the inkjet heads 130. In some embodiments, this may be realized by positioning the ink jet heads 130 using the motor 54 such that the bottoms of the nozzles of the ink jet heads 130 are disposed at a center of the preferred gap range when a portion of the top surface of the box 22 opposite the heads 130 is disposed at the maximum box height.

Following the block 220, a block 222 pauses execution until the box reaches a fourth position at which printing is to commence. A block 224 then operates the ink jet heads 130 to print the box using print data developed by the control system 28. In general, the print data are developed in accordance with the barcode data associated with the box 22. In an embodiment, addressee information, one or more images, and or one or more other indicia are printed by the ink jet heads 130 during operation by the block 224. Also in an embodiment, the barcode data associated with the box 22 is further associated with information regarding an identification of the type and color of the top surface of the box, and print data is modified in accordance with such information to undertake color correction so that the printed content is accurately produced.

Following the block 224, an optional set of blocks 226, 228, and 230 operate an image sensor (not shown, but which may comprise a camera or other optical sensor disposed downstream of the print system 26) to image the printed content, determine if the print quality of the printed content is suitable, and, if this is not found to be the case, an optional diverter apparatus (not shown) is operated to divert the box 22 away from the main conveyance path so that the box 22 is rejected.

If the block 228 determines that the print quality is suitable, or following the block 224 if the blocks 226-230 are not utilized, control passes to a block 232, which transports the printed box 22 for further handling and/or processing as necessary or desirable. A block 234 checks to determine whether the current value of I is equal to the value TEND, which designates the last box to be printed. If this is not found to be the case, then control returns to the block 202 of FIG. 7A. Otherwise, the last box has been printed and the process terminates.

The print system 26 may utilize high resolution ink jet heads 130, such as heads that are capable of printing at 600 dots per inch (dpi) or even 1200 dpi, or low or medium resolution heads having, for example, 100 dpi or 300 dpi print resolution or combinations of print heads. In the latter case, low or medium print resolution heads may print some information, such as addressee information, and high resolution heads may print high quality images. In an embodiment, combination(s) of sets of ink jet print heads are disposed on a single carrier, although the same or different numbers of heads may be disposed on separate carriers. In any embodiment, the carrier(s) are movable up and down by one or more actuators under control of the control system 28 so that each head is maintained at its preferred gap range.

### INDUSTRIAL APPLICABILITY

In summary, embodiments disclosed herein are advantageous in that a single system includes the capability to print directly on packages., In addition, the system and method automatically detect and adjust for varying box heights during a single print sequence.

It should be apparent to those who have skill in the art that any combination of hardware and/or software may be used to implement components of the system 20 described herein. It will be understood and appreciated that one or more of the processes, sub-processes, and process steps described in connection with the FIGS. may be performed by hardware, software, firmware or a combination of hardware, software, and firmware on one or more electronic or digitally-controlled devices. The software or firmware may reside in a memory (not shown) in a suitable electronic processing component or system such as, for example, one or more of the functional systems, controllers, devices, components, modules, or sub-modules depicted in the FIGS. The memory may include an ordered listing of executable instructions for implementing logical functions (that is, “logic” that may be implemented in digital form such as digital circuitry or source code, or in analog form such as analog source such as an analog electrical, sound, or video signal). The instructions may be executed within a processing module or controller (e.g., the control system 28), which includes, for example, one or more microprocessors, general purpose processors, combinations of processors, digital signal processors (DSPs), field programmable gate arrays (FPGAs), application-specific integrated circuits (ASICs), and/or graphics processing units (GPUs). Further, the schematic diagrams describe a logical division of functions having physical (hardware, software and/or firmware) implementations that are not limited by architecture or the physical layout of the functions. The example systems described in this application may be implemented in a variety of configurations and operate as hardware/software/firmware components in a single hardware/software/firmware unit, or in separate hardware/software/firmware units.

Depending on certain implementation requirements, the embodiments described can be implemented using a non-transitory storage medium such as a digital storage medium, for example, a DVD, a Blu-Ray, a CD, a ROM, a PROM, and EPROM, an EEPROM or a FLASH memory having electronically readable control signals stored thereon, which cooperate (or are capable of cooperating) with a programmable computer system such that the respective method is performed. Therefore, the digital storage medium may be computer readable.

Some embodiments disclosed herein comprise a data carrier having electronically readable control signals, which are capable of cooperating with a processor, a controller, or a programmable computer system, such that at least one of the methods described herein is performed.

Generally, embodiments disclosed herein can be implemented as a computer program product with a program code, the program code being operative for performing at least one of the methods disclosed herein when the computer program product runs on a computer. The program code may, for example, be stored on a machine-readable carrier.

Other embodiments comprise the computer program for performing one of the methods described herein, stored on a machine-readable carrier.

In other words, an embodiment, therefore, may include a computer program having a program code for performing one of the methods described herein, when the computer program runs on a processor, a controller, and/or a computer.

A further embodiment of the system described herein is, therefore, a storage medium (or a data carrier, or a computer-readable medium) comprising, stored thereon, the computer program for performing at least one of the methods described herein when it is performed by a processor. The data carrier, the digital storage medium or the recorded medium are typically tangible and/or non-transitory. A further embodiment of the present invention is an apparatus as described herein comprising a processor and the storage medium.

A further embodiment of the system described herein is, therefore, a data stream or a sequence of signals representing the computer program for performing one of the methods described herein. The data stream or the sequence of signals may, for example, be configured to be transferred via a data communication connection, for example, via the internet.

A further embodiment comprises a processing means, for example, a computer or a programmable logic device, configured to, or adapted to, perform one of the methods described herein.

A further embodiment comprises a computer having installed thereon the computer program for performing one of the methods described herein.

A further embodiment comprises an apparatus or a system configured to transfer (for example, electronically or optically) a computer program for performing at least one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example, a field programmable gate array) may be used to perform some or all of the functionalities of some or all of the methods described herein. In some embodiments, a field programmable gate array may cooperate with a microprocessor in order to perform one of the methods described herein. Generally, the methods are preferably performed by any hardware apparatus.

While particular embodiments of the present invention have been illustrated and described, it would be apparent to those skilled in the art that various other changes and modifications can be made and are intended to fall within the spirit and scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

All references, including publications, patent applications, and patents, cited herein are hereby incorporated by reference to the same extent as if each reference were individually and specifically indicated to be incorporated by reference and were set forth in its entirely herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A printing system, comprising:
a conveyor;
at least one ink jet head;
an actuator operable to move the at least one ink jet head relative to the conveyor;
a first sensor and a second sensor adapted to sense a particular dimension and an entire area of a surface of a package, respectively; and
a control system responsive to the first sensor and the second sensor and operable to position the at least one ink jet head for printing.

2. The printing system of claim 1, wherein the first sensor senses package height at a first resolution.

3. The printing system of claim 2, wherein the second sensor senses package height at a second resolution finer than the first resolution.

4. The printing system of claim 1, wherein the first sensor comprises at least one emitter/detector to sense at least one distance.

5. The printing system of claim 1, wherein the first sensor comprises a plurality of emitters/detectors to sense multiple distances.

6. The printing system of claim 1, wherein the first sensor is operable at intervals to sense multiple distances.

7. The printing system of claim 1, wherein the second sensor comprises a micrometer to sense a plurality of distances.

8. The printing system of claim 7, wherein the first sensor is operable to sense a first plurality of heights at a first resolution and the micrometer is operable to sense a second plurality of heights at a second resolution finer than the first resolution.

9. The printing system of claim 8, wherein the control system is operable to move a print apparatus to a position within a range of gap distances from the package.

10. The printing system of claim 1, wherein the at least one ink jet head is a piezoelectric printhead.

11. The printing system of claim 1, wherein the at least one ink jet head is a drop on demand ink jet printhead.

12. The printing system of claim 1, wherein the at least one ink jet head is disposed in a print head housing wherein the actuator moves the print head housing to move the at least one ink jet head.

13. The printing system of claim 12, wherein the print head housing comprises at least four ink jet heads disposed therein.

14. A method of printing on packages, the method comprising the steps of:
operating a first sensor to measure a dimension of a package to obtain an approximate dimension measurement;
establishing a position of a second sensor in dependence upon the approximate dimension measurement;
operating the second sensor to measure the dimension of the package to obtain a further dimension measurement;
disposing a print apparatus at a position dependent upon the further dimension measurement; and
operating the print apparatus to print on a surface of the package.

15. The method of claim 14, wherein the step of operating the first sensor comprises the step of operating at least one emitter/detector to sense at least one distance.

16. The method of claim 14, wherein the step of operating the first sensor comprises the step of operating a plurality of emitters/detectors to sense multiple distances.

17. The method of claim 14, wherein the step of operating the second sensor comprises the step of operating a micrometer to sense a plurality of distances.

18. The method of claim 14, wherein the step of operating the second sensor comprises the step of operating a light sensor to sense a plurality of distances.

19. The method of claim 14, wherein each of the steps of operating the first and second sensors comprises the step of sensing a height of the package.

20. The method of claim 19, wherein the step of disposing the print apparatus comprises the step of moving the print apparatus to a position within a range of gap distances from the package.
